(19) United States
(12) Patent Application Publication
(10) Pub. No.: US 2026/0080438 A1
(43) Pub. Date: Mar. 19, 2026

(54) METHODS AND SYSTEMS FOR DETERMINING TARGETED CONTENT

(71) Applicant: Comcast Cable Communications, LLC, Philadelphia, PA (US)

(72) Inventor: Sandhya Baskaran, Chennai (IN)

(21) Appl. No.: 18/887,764

(22) Filed: Sep. 17, 2024

(51) Int. Cl. G06Q 30/0251

(52) U.S. Cl. CPC G06Q 30/0269

(57) ABSTRACT

Methods, apparatuses, and systems are described for determining targeted content. A user device may receive targeted content based on user profile data stored and maintained on the user device. The user device may receive one or more combinations of content parameters associated with one or more advertisement content items from a computing device. The user device may send an indication of a combination of content parameters of the one or more combinations of content parameters based on a correlation between user profile data and the combination of content parameters to the computing device. The computing device may send an advertisement content item to the user device, that is associated with the combination of content parameters.

### BACKGROUND

Conventional advertisement placement methods involve the use of user profiles for providing targeted advertising. Such user profiles may provide insight into a user's habits, personality, and shopping trends, in addition to various other details about an individual's life. However, these user profiles are often stored at a headend or server external to the user device, and thus, are often plagued with major privacy concerns. The data that is collected and used to build the user profiles and interest segments can be easily accessed or perused by third parties, such as data brokers and other audience intelligence providers, that a user may not wish to share his/her information with. For example, there have been numerous public revelations regarding the easy access that is provided to aggregated user data by some of the largest social media platforms. As a result, sensitive information about an individual may be discovered and misused.

### SUMMARY

It is to be understood that both the following general description and the following detailed description are examples and explanatory only and are not restrictive. Methods, systems, and apparatuses for determining targeted content are disclosed.

A user device may receive targeted content based on user profile data stored and maintained on the user device. The user device may receive one or more combinations of content parameters associated with one or more advertisement content items from a computing device. The one or more combinations of content parameters may comprise one or more advertisement recipes for determining an advertisement content item to output at the user device. The user device may send an indication of a combination of content parameters of the one or more combinations of content parameters based on a correlation between the user profile data and the combination of content parameters to the computing device. The computing device may send an advertisement content item to the user device that is associated with the combination of content parameters.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 shows an example system for determining targeted content;

FIG. 2 shows an example process for determining targeted content;

FIG. 3 shows a flowchart of an example method;

FIG. 4 shows a flowchart of an example method;

FIG. 5 shows a flowchart of an example method;

FIG. 6 shows a flowchart of an example method; and

FIG. 7 shows a block diagram of an example system and computing device.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

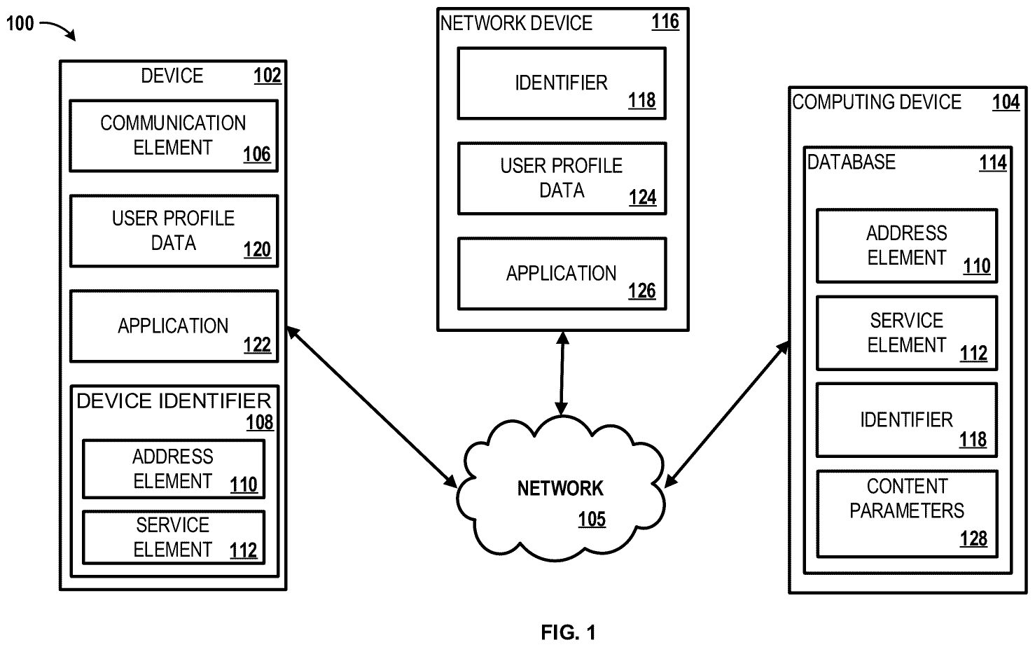

FIG. 1 shows an example system 100 for determining targeted content (e.g., advertisement content) based on user profile data stored and maintained at a user device. For example, the system 100 may be configured to determine an advertisement content item to send to the user device based on one or more combinations of content parameters (e.g., one or more advertisement recipes) associated with one or more advertisement content items and user profile data associated with a user and/or the user device. The system 100 may comprise a device 102, a network device 116, and/or a computing device 104. The device 102 and/or the network device 116 may be in communication with the computing device 104 such as a centralized device or a server, for example. The computing device 104 may be disposed remotely relative to the device 102 and the network device 116. As an example, the device 102, the network device 116, and the computing device 104 may be in communication via a private and/or public network 105 such as the Internet or a local area network. Other forms of communications can be used such as wired and wireless telecommunication channels.

The device 102 may comprise electronic devices such as a computer, a smartphone, a laptop, a tablet, a set top box, a display device, a printer, a network device, a communication terminal, or other device capable of communicating with the network device 116 and the computing device 104. As an example, the device 102 may comprise a communication element 106 for offering an interface to a user to interact with the device 102, the network device 116, and/or the computing device 104. The communication element 106 may be any interface for presenting and/or receiving information to/from the user, such as media content. As an example, the interface may be a communication interface such as a web browser (e.g., Internet Explorer®, Mozilla Firefox®, Google Chrome®, Safari®, or the like). Other software, hardware, and/or interfaces can be used to facilitate communication between the user and one or more of the device 102 and the network device 116. As an example, the communication element 106 can request or query various files from a local source and/or a remote source. As an example, the communication element 106 can transmit data to a local or remote device such as the network device 116 or the computing device 104 via the network device 116.

The device 102 may be associated with a user identifier or a device identifier 108. As an example, the device identifier 108 may be any identifier, token, character, string, or the like, for differentiating one user or user device (e.g., device 102) from another user or user device. The device identifier 108 may identify a user or user device as belonging to a particular class of users or user devices. As an example, the device identifier 108 may comprise information relating to the user device such as a manufacturer, a model or type of device, a service provider associated with the device 102, a state of the device 102, a locator, and/or a label or classifier. Other information can be represented by the device identifiers 108.

The device identifier 108 may comprise address element 110 and service element 112. The address element 110 may comprise or make available an internet protocol address, a network address, a media access control (MAC) address, an Internet address, or the like. As an example, the address element 110 may be relied upon to establish a communication session between the device 102 and the network device 116 or other devices and/or networks. As an example, the address element 110 may be used as an identifier or locator of the device 102. The address element 110 may be persistent for a particular network.

The service element 112 may comprise identification of the service providers associated with the device 102 and/or with the class of device 102. The class of the device 102 may be related to a type of device, a capability of a device, a type of service being offered, and/or a level of service (e.g., a business class, a service tier, a service package, etc.). As an example, the service element 112 may comprise information relating to or made available by a communication service provider (e.g., an Internet service provider) that is offering or enabling data flow such as communication services to the device 102. As an example, the service element 112 may comprise information relating to a preferred service provider for one or more particular services relating to the device 102. The address element 110 may be used to identify or retrieve data from the service element 112, or vice-versa. As an example, one or more of the address element 110 and the service element 112 may be stored remotely from the device 102 and retrieved by one or more devices such as the device 102 and the computing device 104. Other information may be represented by the service element 112.

The network device 116 may be in communication with a network, such as network 105. As an example, the network device 116 may be configured as a set top box. As an example, one or more of the network devices 116 may be configured to facilitate the connection of a device, such as the device 102, to the network 105. As an example, the network device 116 may be configured as a wireless access points (WAPs) or router. The network device 116 may be configured to allow one or more wireless devices to connect to a wired and/or wireless network using Wi-Fi, Bluetooth ®, Zigbee ®, or any desired method or standard.

The network device 116 may be configured as a local area network (LAN). As an example, the network device 116 may comprise a dual band wireless access point. As an example, the network device 116 may be configured with a first service set identifier (SSID) (e.g., associated with a user network or a private network) to function as a local network for a particular user or users. As an example, the network device 116 may be configured with a second service set identifier (SSID) (e.g., associated with a public/community network or a hidden network) to function as a secondary network or redundant network for connected communication devices.

The network device 116 may comprise identifier 118. As an example, one or more identifiers may be or relate to an Internet Protocol (IP) Address IPV4/IPV6 or a media access control address (MAC address) or the like. As an example, the identifier 118 may be unique identifiers for facilitating communications on the physical network segment. The network device 116 may comprise an identifier 118 that is distinct. As an example, the identifier 118 may be associated with a physical location of the network device 116.

The device 102 and/or the network device 116 may store and maintain user profile data 120, 124, respectively, that may be used to receive targeted content (e.g., an advertisement content item). In an example, the device 102 and/or the network device 116 may include applications 122, 126, respectively, which may be partially or fully executed in a device environment of the device 102 and/or the network device 116 for causing the advertisement content item to be inserted into a content stream for output at the device 102 and/or the network device 116 based on the user profile data 120, 124. The user profile data 120, 124 may comprise user history/viewing data associated with one or more users and/or the device 102 and/or the network device 116. For example, the user profile data 120, 124 may comprise user information associated with a content type preference (e.g., animation content, action movies, musicals, music, television shows/series, etc.), a content length preference, demographic information, or one or more environmental factors (e.g., temperature (e.g., hot, cold, etc.), mood (e.g., happy, sad, angry, etc.), ambience, etc.). The device 102 and/or the network device 116 may receive one or more combinations of content parameters (e.g., one or more advertisement recipes) associated with one or more advertisement content items from a computing device (e.g., computing device 104, server, headend, and the like). For example, the device 102 and/or the network device 116 may send a request for an advertisement content item, based on data associated with a content stream being output by the device 102 and/or the network device 116, to the computing device. The device 102 and/or the network device 116 may receive the one or more combinations of content parameters from the computing device based on the request. As an example, the one or more combinations of content parameters may comprise one or more advertisement recipes for determining an advertisement content item to output at the user device. The data associated with the content stream may comprise a SCTE-35 marker associated with the content stream. For example, one or more SCTE-35 markers may be included in the content stream, or in metadata associated with the content stream, for signaling to the device 102 and/or the network device 116 one or more time points in the content stream for inserting advertisement content (e.g., by sending a request for one or more advertisement content items). In an example, the computing device may initially send the user profile data 120, 124 to the device 102 and/or the network device 116. For example, a user may log in at a separate user device (e.g., device 102, network device 116, etc.), wherein the computing device may send the user profile data 120, 124 to the separate user device for the separate user device to store and maintain the user profile data 120, 124.

Each content parameter of each combination of content parameters may be associated with one or more of a location, a product or service being advertised, a type of product or service, a type of content item, a duration, a number of replays, a price, a budget, or demographic information. At least one of the content parameters of each combination of the one or more combinations of content parameters may be associated with, or comprise, a location where an advertisement content item is scheduled to be output. For example, a service provider (e.g., the computing device) may send each combination of content parameters to user devices (e.g., the device 102, the network device 116, etc.) associated with specific locations. For example, a combination of content parameters associated with advertisement content items associated with a first brand of cleaning products may be sent to user devices in a first location while a combination of content parameters associated with advertisement content items associated with a second brand of cleaning products may be sent to user devices in a second location. At least one of the content parameters may be associated with advertisement content items associated with a specific content item, service, product, and/or a content type (e.g., product or service being advertised or type of product or service being advertised). At least one of the content parameters may be associated with a partial or complete/full advertisement content item. For example, an advertisement content item may comprise a partial overlay (e.g., object, image, etc.) or a full video content item associated with a product or advertisement for output at the user device. At least one of the content parameters may be associated with an advertisement or product description such as pricing and other details. At least one of the content parameters may be associated with a recommended length/duration of a content item. In example, a first length/duration may be recommended for a first location while a second length/duration may be recommended for a second location. In an example, a content source may provide the recommended length/duration. In an example, a first length/duration may be recommended for a first product or product type while a second length/duration may be recommended for a second product or product type. In an example, a first length/duration may be recommended for a first user demographic while a second length/duration may be recommended for a second user demographic. At least one of the content parameters may be associated with a threshold number of times the content item is to be replayed across a window of time. For example, a different threshold number of replays may be determined based on one or more of a location, user demographic, content, content type, etc. At least one of the content parameters may be associated with a budget for playing a content item. For example, a different budget may be associated with each location of user devices. At least one of the content parameters may be associated with demographic information such as age, gender, etc.

Each combination of content parameters may be associated with a separate/different advertisement content item. As an example, each combination of content parameters may comprise an advertisement recipe for determining the most appropriate advertisement content to provide to a user device. For example, each combination of content parameters may comprise an advertisement recipe comprising Boolean, integer, and/or string values associated with an advertisement content item. For example, a combination of content parameters may comprise a Boolean/string value of “‘location’ (e.g., state/district code), ‘product/advertisement type,’ ‘partial/full advertisement,’ ‘product description,’ ‘time duration,’ ‘replay value,’ ‘budget value,’ ‘demographic string value.’” For example, a combination of content parameters may comprise ‘“California,’ ‘soap,’ ‘partial generation,’ ‘$25, 5% discount, homemade soap,’ ‘2mins30sec,’ ‘3 replays,’ ‘$3000,’ ‘male, 21-30,’” associated with an advertisement content item advertising a soap product for users located in California, that is an overlay (e.g., object, image, etc.), that costs $25 for a 5% discount and is a homemade product, for a length of 2 minutes and 30 seconds, that is to be replayed 3 times, that is budgeted for $3,000, that is directed to a male audience comprising an age group between 21 and 30 years old. For example, a combination of content parameters may comprise ‘“Georgia,’ ‘video game,’ ‘full advertisement,’ ‘basketball video game,’ ‘2min,’ ‘5 replays,’ ‘$5000,’ ‘male, 13-25,’” associated with an advertisement content item advertising a basketball video game for users located in Georgia, that is a full advertisement video content item, for a length of 2 minutes, that is to be replayed 5 times, that is budgeted for $5,000, that is directed to a male audience comprising an age group between 13 and 25 years old.

The applications 122, 126 may cause the device 102 and/or the network device 116 to compare user profile data 120, 124 with the one or more combinations of content parameters (e.g., one or more advertisement recipes). For example, the device 102 and/or the network device 116 may process the one or more combinations of content parameters to correlate at least one combination of content parameters with the user profile data in order receive an advertisement content item based on the combination of content parameters. Thus, the user profile data remains on the device 102 and/or the network device 116 and the device 102 and/or the network device 116 may receive targeted content (e.g., an advertisement content item) without having to send the user profile to, or share the user profile data with, an external computing device, such as computing device 104, preventing sensitive user information from being discovered and/or misused by a third party, for example. Based on a correlation of the user profile data 120, 124 and a combination of content parameters, the applications 122, 126 may cause the device 102 and/or the network device 116 to send an indication of the combination of content parameters to the computing device. The device 102 and/or the network device 116 may receive a content item associated with the combination of content parameters from the computing device.

In an example, the device 102 and/or the network device 116 may generate the content item (e.g., via the applications 122, 126). Based on the correlation of the user profile data 120, 124 and the combination of content parameters, the applications 122, 126 may generate content description data for generating an advertisement content item. In an example, the applications 122, 126 may generate the content description data based on an application of a machine learning model (e.g., generative artificial intelligence, neural network, etc.) to the combination of content parameters and the user profile data. As an example, the content description data may be associated with a “story” for generating the content item. For example, the content description data, or the “story,” may comprise a string value such as “generate a soap advertisement priced at $28 for an age group consisting of 20-40 year-old adults with an animation content for a length of 5 seconds.” For example, the string value may comprise “generate a toy advertisement priced at $20 for a house hold consisting of a family with at least one child in the 2-10 year-old age group with cartoon content for a length of 1 minutes.” In an example, the string value (e.g., the content description data, or the “story”) may be provided to a machine learning model (e.g., generative artificial intelligence, neural network, etc.), wherein the machine learning model may generate the advertisement content item.

In an example, the device 102 and/or the network device 116 may receive the advertisement content item based on sending the computing device data indicative of the advertisement content item. For example, the applications 122, 126 may cause the device 102 and/or the network device 116 to determine the data indicative of the advertisement content item based on the combination of content parameters. For example, the data indicative of the advertisement content item may comprise metadata comprising information (e.g., description of the advertisement content item) associated with the advertisement content item. For example, the device 102 and/or the network device 116 may receive data indicative of each advertisement content item, of the one or more advertisement content items, associated with each combination of content parameters from the computing device. For example, the data indicative of each advertisement content item may comprise metadata comprising descriptions of each advertisement content item. The device 102 and/or the network device 116 may determine the data indicative of the advertisement content item based on comparing the combination of content parameters with the data indicative of each advertisement content item. The applications 122, 126 may cause the device 102 and/or the network device 116 to send the data indicative of the advertisement content item to the computing device, wherein the computing device may send the advertisement content item to the device 102 and/or the network device 116 based on the data indicative of the advertisement content item.

The device 102 and/or the network device 116 may output the received content item. For example, the applications 122, 126 may cause the device 102 and/or the network device 116 to insert the advertisement content item into the content stream for output at the device 102 and/or the network device 116. In an example, the applications 122, 126 may determine the proper placement of the advertisement content item. For example, the applications 122, 126 may determine when (e.g., time of day, during certain content or types of content, etc.) to output the advertisement content item. The applications 122, 126 may determine when to output the advertisement content item based on one or more content parameters of the combination of content parameters and/or the user profile data. After the advertisement content item is output, impact data (e.g., user statistics) of the output advertisement content item may be determined. For example, a number of users that viewed the output advertisement content item and user/audience sentiment (e.g., positive, negative, or neutral) towards the output advertisement content item may be determined. The impact data of the output advertisement content item may be sent to the service provider (e.g., computing device 104, server, headend, etc.).

The computing device 104 may comprise a server, or a centralized device, for communicating with the network device 116, the device 102, and the like within the network 105. In an example, the computing device 104 may communicate with the device 102 for offering data and/or services. For example, the computing device 104 may offer services such as network (e.g., Internet) connectivity, network printing, media management (e.g., a media server), interference management, content services, streaming services, broadband services, or other network-related services.

The computing device 104 may allow the device 102 and/or the network device 116 to interact with remote resources such as data, devices, and files. As an example, the computing device 104 may be configured as (or disposed at) a central location (e.g., a headend, or a processing facility), which can receive content (e.g., data, input programming) from multiple sources. In an example, the computing device 104 may be a separate/remote device from the server for determining malicious activity within the communication network (e.g., network 105). The computing device 104 can combine the content from the multiple sources and can distribute the content to user (e.g., subscriber) locations via a distribution system.

The computing device 104 may be configured to manage the communication between the device 102 and the network device 116 and a database 114 (e.g., storage system) for sending and receiving data therebetween. As an example, the database 114 may be configured to store a plurality of files, user identifiers or records, or other information. As an example, the device 102 and/or the network device 116 may request and/or retrieve one or more files from the database 114. The database 114 may store information relating to the device 102 such as the address element 110 and/or the service element 112. As an example, the computing device 104 may obtain the device identifier 108 and/or 118 from the device 102 and/or the network device 116 and retrieve information from the database 114 such as the address element 110 and/or the service element 112. As a further example, the computing device 104 may obtain the address element 110 from the device 102 and/or the network device 116 and may retrieve the service element 112 from the database 114, or vice versa. The database 114 may be integrated with the computing device 104 or some other device or system.

The computing device 104 may send one or more combinations of content parameters 128 associated with one or more advertisement content items to a user device (e.g., device 102, network device 116, etc.). For example, the computing device 104 may generate each combination of content parameters 128 of the one or more combinations of content parameters 128 based on each advertisement content item of the one or more advertisement content items. In an example, the computing device 104 may send each combination of content parameters 128 to one or more user devices based on locations of each user device of the one or more user devices and/or based on a request from each user device. In an example, the computing device 104 may receive an indication of a combination of content parameters of the one or more combinations of content parameters from the user device, wherein the user device determines the indication of the combination of content parameters based on a correlation between user profile data associated with the user device and the combination of content parameters. Based on the combination of content parameters, the computing device 104 may send an advertisement content item of the one or more advertisement content items to the user device, wherein the user device may insert the advertisement content item into a content stream for output at the user device. In an example, the computing device 104 may receive data indicative of the advertisement content item from the user device. For example, the computing device 104 may send data indicative of each advertisement content item to the user device, wherein the user device may send the data indicative of the advertisement content item to the computing device 104 based on comparing the combination of content parameters with the data indicative of each advertisement content item. The computing device 104 may send the advertisement content item to the user device based on the data indicative of the advertisement content item received from the user device.

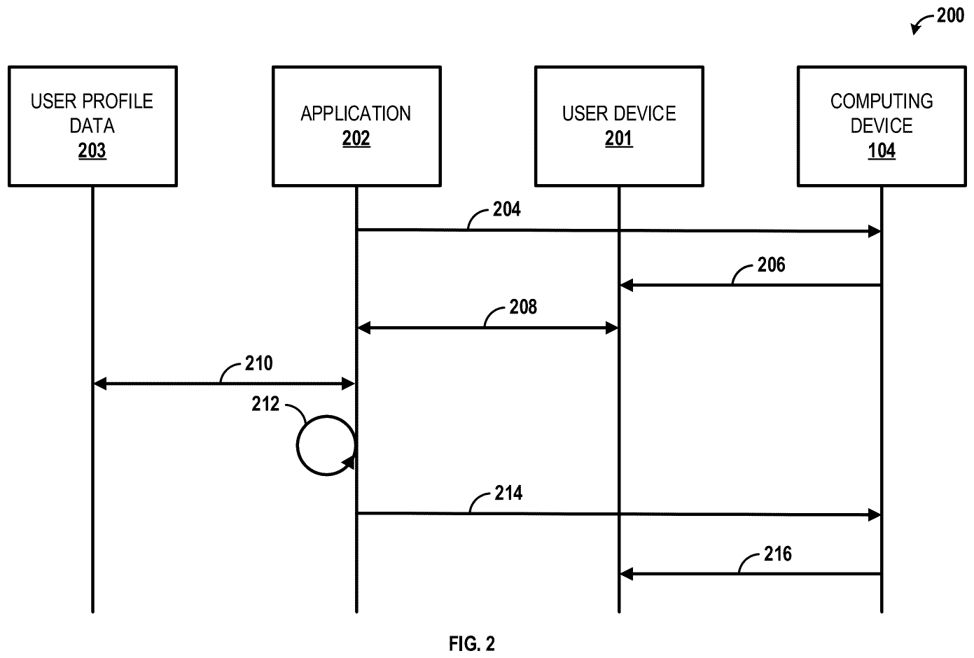

FIG. 2 shows an example process 200 for determining targeted content. At 204, a user device 201 (e.g., device 102, network device 116, etc.) may send a request for an advertisement content item. For example, the user device 201 may send the request for the advertisement content item based on data associated with the content stream. The data associated with the content stream may comprise a SCTE-35 marker associated with the content stream. For example, one or more SCTE-35 markers may be included in the content stream, or in metadata associated with the content stream, for signaling to the user device one or more time points in the content stream for inserting advertisement content (e.g., via a request for one or more advertisement content items). At 206, the user device 201 may receive one or more combinations of content parameters (e.g., one or more advertisement recipes) associated with one or more advertisement content items from the computing device 104. For example, the user device 201 may receive the one or more combinations of content parameters based on the request. In an example, the computing device 104 may generate the one or more combinations of content parameters based on the one or more advertisement content items and send the one or more combinations of content parameters to the user device 201. Each combination of content parameters may be associated with one or more of a location, a product or service being advertised, a type of product or service, a type of content item, a duration, a number of replays, a price, a budget, or demographic information. At 208, an application 202 (e.g., applications 122, 126) may access the one or more combinations of content parameters, and at 210, the application 201 may access user profile data 203 (e.g., user profile data 120, 124) that may be stored and maintained on the user device 201. For example, the user profile data 203 may comprise user information associated with a content type preference (e.g., animation content, action movies, musicals, music, television shows/series, etc.), a content length preference, demographic information, or one or more environmental factors (e.g., temperature (e.g., hot, cold, etc.), mood (e.g., happy, sad, angry, etc.), ambience, etc.). At 212, the application 202 may compare the user profile data 203 with the one or more combinations of content parameters. At 214, based on a correlation between the user profile data 203 and a combination of content parameters of the one or more combinations of content parameters, the application 202 may send an indication of the combination of content parameters to the computing device 104. For example, the application 302 may cause the user device 301 to send the indication to the computing device 104. At 216, the computing device 104 may send an advertisement content item associated with the combination of content parameters to the user device 201. In an example, the user device 201 may insert the advertisement content item into the content stream for output at the user device 201. For example, the application 202 may determine a placement of the advertisement content item in the content stream for output at the user device 201. For example, the application 202 may determine when (e.g., time of day, during certain content or types of content, etc.) to output the advertisement content item. The application 202 may determine when to output the advertisement content item based on one or more content parameters of the combination of content parameters and/or the user profile data 203.

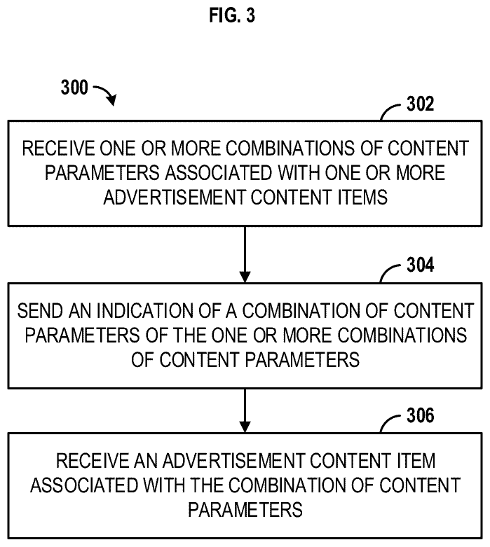

FIG. 3 shows a flowchart of an example method 300. Method 300 may be implemented, for example, by a user device (e.g., device 102, network device 116, and the like). At step 302, one or more combinations of content parameters (e.g., one or more advertisement recipes) associated with one or more advertisement content items may be received. For example, a user device (e.g., device 102, network device 116, and the like) may receive the one or more combinations of content parameters associated with the one or more advertisement content items. Each combination of content parameters may be associated with one or more of a location, a product or service being advertised, a type of product or service, a type of content item, a duration, a number of replays, a price, a budget, or demographic information. In an example, the user device may send a request for an advertisement content item based on data associated with a content stream. The one or more advertisement content items may be received based on the request. The data associated with the content stream may comprise a SCTE-35 marker associated with the content stream. For example, one or more SCTE-35 markers may be included in the content stream, or in metadata associated with the content stream, for signaling to the user device one or more time points in the content stream for inserting advertisement content (e.g., via a request for one or more advertisement content items). In an example, a computing device (e.g., computing device 104, server, headend, router, and the like) may generate each combination of content parameters of the one or more combinations of content parameters based on each advertisement content item of the one or more advertisement content items.

At step 304, an indication of a combination of content parameters of the one or more combinations of content parameters may be sent based on a correlation between user profile data and the combination of content parameters of the one or more combinations of content parameters. For example, the user device (e.g., device 102, network device 116, and the like) may send the indication of the combination of content parameters of the one or more combinations of content parameters to a computing device (e.g., computing device 104, server, headend, router, and the like) based on the correlation between the user profile data and the combination of content parameters of the one or more combinations of content parameters. The user profile data may comprise user information associated with a content type preference (e.g., animation content, action movies, musicals, music, television shows/series, etc.), a content length preference, demographic information, or one or more environmental factors (e.g., temperature (e.g., hot, cold, etc.), mood (e.g., happy, sad, angry, etc.), ambience, etc.).

At step 306, an advertisement content item associated with the combination of content parameters may be received. For example, the user device (e.g., device 102, network device 116, and the like) may receive the advertisement content item associated with the combination of content parameters from the computing device (e.g., computing device 104, server, headend, router, and the like). The user device may cause the advertisement content item to be inserted into the content stream for output at the user device. In an example, the user device may determine a placement of the advertisement content item. For example, the user device may determine when (e.g., time of day, during certain content or types of content, etc.) to output the advertisement content item. The user device may determine when to output the advertisement content item based on one or more content parameters of the combination of content parameters and/or the user profile data. After the advertisement content item is output, impact data (e.g., user statistics) of the output advertisement content item may be determined. For example, a number of users that viewed the output advertisement content item and user/audience sentiment (e.g., positive, negative, or neutral) towards the output advertisement content item may be determined. The impact data of the output advertisement content item may be sent to the computing device.

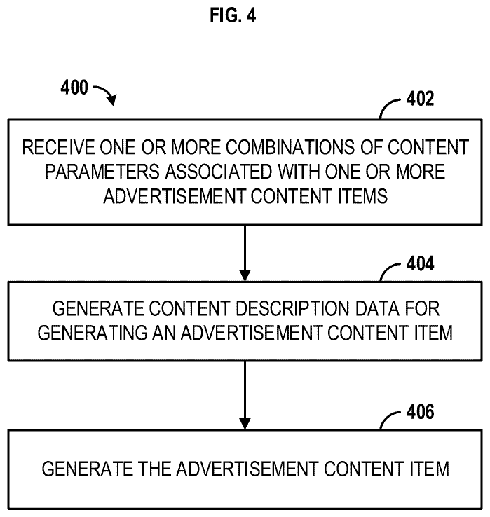

FIG. 4 shows a flowchart of an example method 400. Method 400 may be implemented, for example, by a user device (e.g., device 102, network device 116, and the like). At step 402, one or more combinations of content parameters associated with one or more advertisement content items may be received. For example, a user device (e.g., device 102, network device 116, and the like) may receive the one or more combinations of content parameters associated with the one or more advertisement content items. Each combination of content parameters may be associated with one or more of a location, a product or service being advertised, a type of product or service, a type of content item, a duration, a number of replays, a price, a budget, or demographic information. In an example, the user device may send a request for an advertisement content item based on data associated with a content stream. The one or more advertisement content items may be received based on the request. The data associated with the content stream may comprise a SCTE-35 marker associated with the content stream. For example one or more SCTE-35 markers may be included in the content stream, or in metadata associated with the content stream, for signaling to the user device one or more time points in the content stream for inserting advertisement content (e.g., via a request for one or more advertisement content items). In an example, a computing device (e.g., computing device 104, server, headend, router, and the like) may generate each combination of content parameters of the one or more combinations of content parameters based on each advertisement content item of the one or more advertisement content items.

At step 404, content description data for generating an advertisement content item may be generated based on a correlation between user profile data associated with the user device and a combination of content parameters of the one or more combinations of content parameters. For example, the user device (e.g., device 102, network device 116, and the like) may generate the content description data for generating the advertisement content item based on the correlation between the user profile data associated with the user device and the combination of content parameters of the one or more combinations of content parameters. The user profile data may comprise user information associated with a content type preference (e.g., animation content, action movies, musicals, music, television shows/series, etc.), a content length preference, demographic information, or one or more environmental factors (e.g., temperature (e.g., hot, cold, etc.), mood (e.g., happy, sad, angry, etc.), ambience, etc.). As an example, the content description data may be associated with a “story” for generating the content item. For example, the content description data, or the “story,” may comprise a string value such as “generate a soap advertisement priced at $28 for an age group consisting of 20-40 year-old adults with an animation content for a length of 5 seconds.” For example, the string value may comprise “generate a toy advertisement priced at $20 for a house hold consisting of a family with at least one child in the 2-10 year-old age group with cartoon content for a length of 1 minutes.” In an example, the user device may generate content description data based on an application of a machine learning model (e.g., generative artificial intelligence, neural network, etc.) to the combination of content parameters.

At step 406, an advertisement content item may be generated based on the content description data. For example, the user device (e.g., device 102, network device 116, and the like) may generate the advertisement content item based on the content description data. In an example, the user device may generate the advertisement content item based on an application of a machine learning model (e.g., generative artificial intelligence, neural network, etc.) to content description data. For example, the string value (e.g., the content description data, or the “story”) may be provided to the machine learning model, wherein the machine learning model may generate the advertisement content item. The user device may cause the advertisement content item to be inserted into the content stream for output at the user device. In an example, the user device may determine a placement of the advertisement content item. For example, the user device may determine when (e.g., time of day, during certain content or types of content, etc.) to output the advertisement content item. The user device may determine when to output the advertisement content item based on one or more content parameters of the combination of content parameters and/or the user profile data. After the advertisement content item is output, impact data of the output advertisement content item may be determined. For example, a number of users that viewed the output advertisement content item and user/audience sentiment (e.g., positive, negative, or neutral) towards the output advertisement content item may be determined. The impact data of the output advertisement content item may be sent to the computing device.

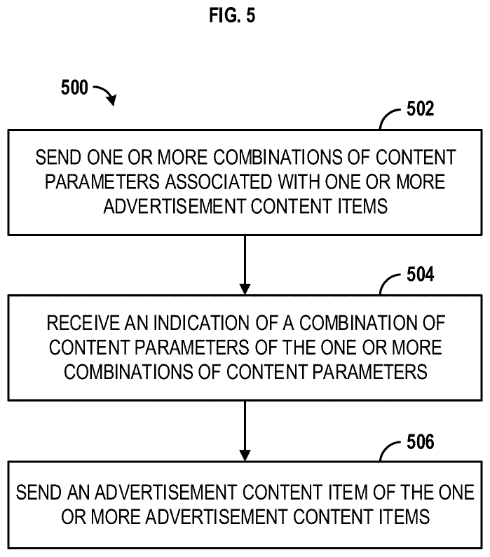

FIG. 5 shows a flowchart of an example method 500. Method 500 may be implemented, for example, by a computing device (e.g., computing device 104, server, headend, router, and the like). At step 502, one or more combinations of content parameters associated with one or more advertisement content items may be sent. For example, a computing device (e.g., computing device 104, server, headend, router, and the like) may send the one or more combinations of content parameters associated with the one or more advertisement content items to a user device (e.g., device 102, network device 116, and the like). For example, the computing device may generate the one or more combinations of content parameters associated with the one or more advertisement content items based on the one or more advertisement content items. Each combination of content parameters may be associated with one or more of a location, a product or service being advertised, a type of product or service, a type of content item, a duration, a number of replays, a price, a budget, or demographic information. In an example, the user device may send a request for an advertisement content item based on data associated with a content stream. The one or more advertisement content items may be received based on the request. The data associated with the content stream may comprise a SCTE-35 marker associated with the content stream. For example one or more SCTE-35 markers may be included in the content stream, or in metadata associated with the content stream, for signaling to the user device one or more time points in the content stream for inserting advertisement content (e.g., via a request for one or more advertisement content items).

At step 504, an indication of a combination of content parameters of the one or more combinations of content parameters may be received. For example, the computing device (e.g., computing device 104, server, headend, router, and the like) may receive the indication the combination of content parameters of the one or more combinations of content parameters from the user device (e.g., device 102, network device 116, and the like). In an example, the user device may determine the indication of the combination of content parameters based on a correlation between user profile data associated with the user device and the combination of content parameters. The user profile data may comprise user information associated with a content type preference (e.g., animation content, action movies, musicals, music, television shows/series, etc.), a content length preference, demographic information, or one or more environmental factors (e.g., temperature (e.g., hot, cold, etc.), mood (e.g., happy, sad, angry, etc.), ambience, etc.).

At step 506, an advertisement content item of the one or more advertisement content items may be sent based on the combination of content parameters. For example, the computing device (e.g., computing device 104, server, headend, router, and the like) may send the advertisement content item of the one or more advertisement content items to the user device (e.g., device 102, network device 116, and the like) based on the combination of content parameters. The user device may cause the advertisement content item to be inserted into the content stream for output at the user device. In an example, the user device may determine a placement of the advertisement content item. For example, the user device may determine when (e.g., time of day, during certain content or types of content, etc.) to output the advertisement content item. The user device may determine when to output the advertisement content item based on one or more content parameters of the combination of content parameters and/or the user profile. After the advertisement content item is output, impact data of the output advertisement content item may be determined. For example, a number of users that viewed the output advertisement content item and user/audience sentiment (e.g., positive, negative, or neutral) towards the output advertisement content item may be determined. The impact data of the output advertisement content item may be sent to the computing device.

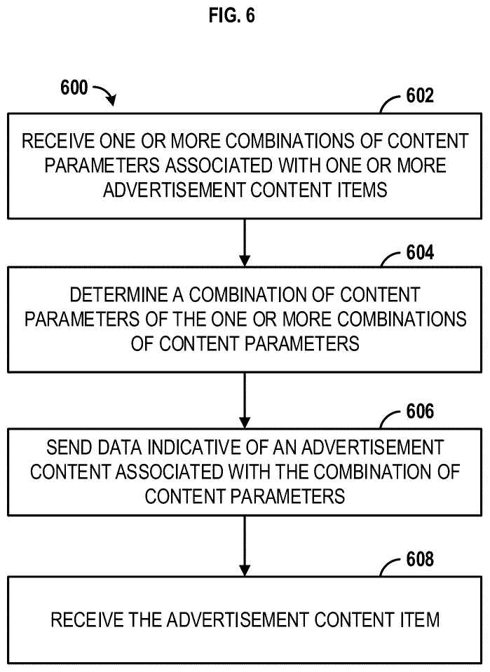

FIG. 6 shows a flowchart of an example method 600. Method 600 may be implemented, for example, by a user device (e.g., device 102, network device 116, and the like). At step 602, one or more combinations of content parameters (e.g., one or more advertisement recipes) associated with one or more advertisement content items may be received. For example, a user device (e.g., device 102, network device 116, and the like) may receive the one or more combinations of content parameters associated with the one or more advertisement content items. Each combination of content parameters may be associated with one or more of a location, a product or service being advertised, a type of product or service, a type of content item, a duration, a number of replays, a price, a budget, or demographic information. In an example, the user device may send a request for an advertisement content item based on data associated with a content stream. The one or more advertisement content items may be received based on the request. The data associated with the content stream may comprise a SCTE-35 marker associated with the content stream. For example, one or more SCTE-35 markers may be included in the content stream, or in metadata associated with the content stream, for signaling to the user device one or more time points in the content stream for inserting advertisement content (e.g., via a request for one or more advertisement content items). In an example, a computing device (e.g., computing device 104, server, headend, router, and the like) may generate each combination of content parameters of the one or more combinations of content parameters based on each advertisement content item of the one or more advertisement content items.

At step 604, an indication of a combination of content parameters of the one or more combinations of content parameters may be sent based on a correlation between user profile data and the combination of content parameters of the one or more combinations of content parameters. For example, the user device (e.g., device 102, network device 116, and the like) may send the indication of the combination of content parameters of the one or more combinations of content parameters to a computing device (e.g., computing device 104, server, headend, router, and the like) based on the correlation between the user profile data and the combination of content parameters of the one or more combinations of content parameters. The user profile data may comprise user information associated with a content type preference (e.g., animation content, action movies, musicals, music, television shows/series, etc.), a content length preference, demographic information, or one or more environmental factors (e.g., temperature (e.g., hot, cold, etc.), mood (e.g., happy, sad, angry, etc.), ambience, etc.).

At step 606, data indicative of an advertisement content item, of the one or more advertisement content items, associated with the combination of content parameters may be sent. For example, the user device (e.g., device 102, network device 116, and the like) may send the data indicative of the advertisement content item, of the one or more advertisement content items, associated with the combination of content parameters to the computing device (e.g., computing device 104, server, headend, router, and the like). For example, the data indicative of the advertisement content item may comprise metadata comprising information (e.g., description of the advertisement content item) associated with the advertisement content item. For example, the user device may receive data indicative of each advertisement content item, of the one or more advertisement content items, associated with each combination of content parameters. For example, the data indicative of each advertisement content item may comprise metadata comprising descriptions of each advertisement content item. The user device may determine the data indicative of the advertisement content item based on comparing the combination of content parameters with the data indicative of each advertisement content item.

At step 608, the advertisement content item may be received based on the data indicative of the advertisement content item. For example, the user device (e.g., device 102, network device 116, and the like) may receive the advertisement content item from the computing device (e.g., computing device 104, server, headend, router, and the like) based on the data indicative of the advertisement content item. For example, the computing device may retrieve the advertisement content item based on receiving the data indicative of the advertisement content item.

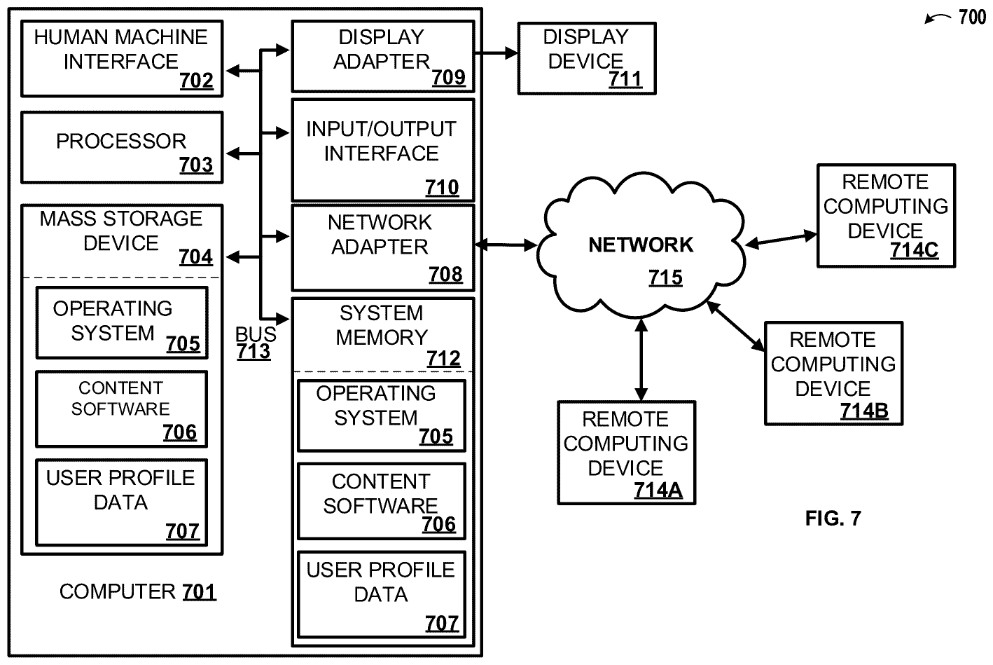

FIG. 7 shows a block diagram illustrating an example computing device. The methods and systems can be implemented on a computer 701 as shown in FIG. 7 and described below. By way of example, device 102, network device 116, and computing device 104 of FIG. 1 can be a computer 701 as illustrated in FIG. 7. Similarly, the methods and systems disclosed can utilize one or more computers to perform one or more functions in one or more locations. FIG. 7 is a block diagram illustrating an exemplary operating environment 700 for performing the disclosed methods. This exemplary operating environment 700 is only an example of an operating environment and is not intended to suggest any limitation as to the scope of use or functionality of operating environment architecture. Neither should the operating environment 700 be interpreted as having any dependency or requirement relating to any one or combination of components illustrated in the exemplary operating environment 700.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media including memory storage devices.

Further, one skilled in the art will appreciate that the systems and methods disclosed herein can be implemented via a general-purpose computing device in the form of a computer 701. The computer 701 can comprise one or more components, such as one or more processors 703, a system memory 712, and a bus 713 that couples various components of the computer 701 including the one or more processors 703 to the system memory 712. In the case of multiple processors 703, the system can utilize parallel computing.

The bus 713 can comprise one or more of several possible types of bus structures, such as a memory bus, memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 713, and all buses specified in this description can also be implemented over a wired or wireless network connection and one or more of the components of the computer 701, such as the one or more processors 703, a mass storage device 704, an operating system 705, content software 706, user profile data 707, a network adapter 708, system memory 712, an Input/Output Interface 710, a display adapter 709, a display device 711, and a human machine interface 702, can be contained within one or more remote computing devices 714A-714C at physically separate locations, connected through buses of this form, in effect implementing a fully distributed system.

The computer 701 typically comprises a variety of computer readable media. Exemplary readable media can be any available media that is accessible by the computer 701 and comprises, for example and not meant to be limiting, both volatile and non-volatile media, removable and non-removable media. The system memory 712 can comprise computer readable media in the form of volatile memory, such as random access memory (RAM), and/or non-volatile memory, such as read only memory (ROM). The system memory 712 typically can comprise data such as user profile data 707 and/or program modules such as operating system 705 and content software 706 that are accessible to and/or are operated on by the one or more processors 703.

The computer 701 can also comprise other removable/non-removable, volatile/non-volatile computer storage media. By way of example, the computer 701 can comprise a mass storage device 704 which can offer non-volatile storage of computer code, computer readable instructions, data structures, program modules, and other data for the computer 701. For example, a mass storage device 704 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 704, including by way of example, an operating system 705 and content software 706. One or more of the operating system 705 and content software 706 (or some combination thereof) can comprise elements of the programming and the content software 706. User profile data 707 can also be stored on the mass storage device 704. User profile data 707 can be stored in any of one or more databases known in the art. Examples of such databases comprise, DB2®, Microsoft® Access, Microsoft® SQL Server, Oracle®, 24ySQL, PostgreSQL, and the like. The databases can be centralized or distributed across multiple locations within the network 715.

The user can enter commands and information into the computer 701 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices can be connected to the one or more processors 703 via a human machine interface 702 that is coupled to the bus 713, but can be connected by other interface and bus structures, such as a parallel port, game port, an IEEE 1394 Port (also known as a Firewire port), a serial port, network adapter 708, and/or a universal serial bus (USB).

A display device 711 can also be connected to the bus 713 via an interface, such as a display adapter 709. It is contemplated that the computer 701 can have more than one display adapter 709 and the computer 701 can have more than one display device 711. For example, a display device 711 can be a monitor, an LCD (Liquid Crystal Display), light emitting diode (LED) display, television, smart lens, smart glass, /d/ or a projector. In addition to the display device 711, other output peripheral devices can comprise components such as speakers (not shown) and a printer (not shown) which can be connected to the computer 701 via Input/Output Interface 710. Any step and/or result of the methods can be output in any form to an output device. Such output can be any form of visual representation, including, but not limited to, textual, graphical, animation, audio, tactile, and the like. The display 711 and computer 701 can be part of one device, or separate devices.

The computer 701 can operate in a networked environment using logical connections to one or more remote computing devices 714A, 714B, and 714C. By way of example, a remote computing device 714A-714C can be a personal computer, a computing station (e.g., a workstation), a portable computer (e.g., a laptop, a mobile phone, a tablet device), a smart device (e.g., a smartphone, a smart watch, an activity tracker, a smart apparel, a smart accessory), a security and/or monitoring device, a server, a router, a network computer, a peer device, an edge device or other common network node, and so on. Logical connections between the computer 701 and a remote computing device 714A-714C can be made via a network 715, such as a local area network (LAN) and/or a general wide area network (WAN). Such network connections can be through a network adapter 708. A network adapter 708 can be implemented in both wired and wireless environments. Such networking environments are conventional and commonplace in dwellings, offices, enterprise-wide computer networks, intranets, and the Internet.

For purposes of illustration, application programs and other executable program components such as the operating system 705 are illustrated herein as discrete blocks, although it is recognized that such programs and components can reside at various times in different storage components of the computer 701, and are executed by the one or more processors 703 of the computer 701. An implementation of content software 706 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques such as machine learning and iterative learning. Examples of such techniques include, but are not limited to, expert systems, case based reasoning, Bayesian networks, behavior based AI, neural networks, fuzzy systems, evolutionary computation (e.g., a genetic algorithms), swarm intelligence (e.g., an ant algorithms), and hybrid intelligent systems (e.g., expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method comprising:
receiving, at a user device, from a computing device, one or more combinations of content parameters associated with one or more advertisement content items;
sending, to the computing device, based on a correlation between user profile data associated with the user device and a combination of content parameters of the one or more combinations of content parameters, an indication of the combination of content parameters of the one or more combinations of content parameters; and
receiving, from the computing device, an advertisement content item associated with the combination of content parameters.

2. The method of claim 1, further comprising sending, by the user device, to the computing device, based on data associated with a content stream, a request for an advertisement content item, wherein receiving the one or more combinations of content parameters associated with the one or more advertisement content items comprises receiving, based on the request, the one or more combinations of content parameters associated with the one or more advertisement content items.

3. The method of claim 2, further comprising causing the advertisement content item to be inserted into the content stream for output at the user device.

4. The method of claim 2, wherein the data associated with the content stream comprises a SCTE-35 marker associated with the content stream.

5. The method of claim 1, wherein each combination of content parameters is associated with one or more of a location, a product or service being advertised, a type of product or service, a type of content item, a duration, a number of replays, a price, a budget, or demographic information.

6. The method of claim 1, wherein the user profile data is stored and maintained on the user device, and wherein the user profile data comprises user information associated with a content type preference, a content length preference, demographic information, or one or more environmental factors.

7. A method comprising:
receiving, at a user device, from a computing device, one or more combinations of content parameters associated with one or more advertisement content items;
generating, based on a correlation between user profile data associated with the user device and a combination of content parameters of the one or more combinations of content parameters, content description data for generating an advertisement content item; and
generating, based on the content description data, the advertisement content item.

8. The method of claim 7, further comprising sending, by the user device, to the computing device, based on data associated with a content stream, a request for an advertisement content item, wherein receiving the one or more combinations of content parameters associated with the one or more advertisement content items comprises receiving, based on the request, the one or more combinations of content parameters associated with the one or more advertisement content items.

9. The method of claim 8, further comprising causing the advertisement content item to be inserted into the content stream for output at the user device.

10. The method of claim 8, wherein the data associated with the content stream comprises a SCTE-35 marker associated with the content stream.

11. The method of claim 7, wherein each combination of content parameters is associated with one or more of a location, a product or service being advertised, a type of product or service, a type of content item, a duration, a number of replays, a price, a budget, or demographic information.

12. The method of claim 7, wherein the user profile data is stored and maintained on the user device, and wherein the user profile data comprises user information associated with a content type, a content length, demographic information, or environmental factors.

13. The method of claim 7, wherein generating, based on the content description data, the advertisement content item comprises generating, based on an application of a machine learning model to the content description data, the advertisement content item.

14. A method comprising:
sending, by a computing device, to a user device, one or more combinations of content parameters associated with one or more advertisement content items;
receiving, from the user device, an indication of a combination of content parameters of the one or more combinations of content parameters, wherein the user device determines the indication of the combination of content parameters based on a correlation between user profile data associated with the user device and the combination of content parameters; and
sending, to the user device, based on the combination of content parameters, an advertisement content item of the one or more advertisement content items.

15. The method of claim 14, wherein the user device sends a request to the computing device for an advertisement content item based on data associated with a content stream, wherein sending the one or more combinations of content parameters comprises sending, based on the request, the one or more combinations of content parameters.

16. The method of claim 15, wherein the user device causes the advertisement content item to be inserted into the content stream for output at the user device.

17. The method of claim 15, wherein the data associated with the content stream comprises a SCTE-35 marker associated with the content stream.

18. The method of claim 14, further comprising generating, based on the one or more advertisement content items, each combination of content parameters of the one or more combinations of content parameters for each advertisement content item of the one or more advertisement content items.

19. The method of claim 14, wherein each combination of content parameters is associated with one or more of a location, a product or service being advertised, a type of product or service, a type of content item, a duration, a number of replays, a price, a budget, or demographic information.

20. The method of claim 14, wherein the user profile data is stored and maintained on the user device, and wherein the user profile data comprises user information associated with a content type preference, a content length preference, demographic information, or one or more environmental factors.
